(19) United States
(12) Patent Application Publication
(10) Pub. No.: US 2023/0042605 A1
(43) Pub. Date: Feb. 9, 2023

(54) INTUITIVE TIPPING SYSTEM FOR USER INTERACTION SYSTEM

(71) Applicant: Thika Holdings LLC, St. Pete Beach, FL (US)

(72) Inventor: Vivien Cambridge, Myrtle Beach, SC (US)

(73) Assignee: Thika Holdings LLC, St. Pete Beach, FL (US)

(21) Appl. No.: 17/791,466

(22) PCT Filed: Jan. 11, 2021
(86) PCT No.: PCT/US2021/012928

§ 371 Date: Jul. 7, 2022

Related U.S. Application Data
(60) Provisional application No. 62/959,919, filed on Jan. 11, 2020.

(51) Int. Cl. G06Q 20/10; A61H 19/00; G06F 3/01; G06Q 20/12

(52) U.S. Cl. CPC G06Q 20/10; A61H 19/30; G06F 3/011; G06F 3/017; G06Q 20/123; A61H 2201/1253; A61H 2201/5005; A61H 2201/5012; A61H 2201/1207

(57) ABSTRACT

In one aspect, an interactive system is disclosed that includes a first sex toy including a sensor that is configured to be engaged by a first user. Manipulation of the first sex toy is detected by the sensor and triggers the interactive system to provide compensation to a second user. In another aspect, a wristband sensor is provided that is configured to attach to a first user's body and the sensor is configured to send signals to a central server which determines compensation for a second user.

### CROSS REFERENCE TO RELATED APPLICATION

This application claims the benefit of U.S. Provisional Application No. 62/959,919, filed Jan. 11, 2020, the entirety of which is incorporated by reference as if fully set forth herein.

### BACKGROUND OF THE INVENTION

Interaction between users over the internet can occur in a variety of ways and using a variety of interactive systems and configurations.

For example, in the adult entertainment or webcam industry, a customer (e.g., a first user) typically views a webcam performer or entertainer (e.g., a second user) via a live video feed. The customer may tip the webcam performer or entertainer using a website interface, such as by using their mouse or keyboard to enter tipping amounts. The customer may also be able to set parameters regarding the size and frequency of the tip using their mouse or keyboard.

Any non-performer interaction with the computer can dilute the immersive interaction between the customer and performer. In situations where the customer is attempting to pay attention to the webcam performer, or simultaneously using a masturbatory aid or sex toy, the process of also engaging a mouse or keyboard is distracting and inconvenient.

Accordingly, it would be desirable to provide an intuitive and convenient way for a first user to provide compensation or tips to a second user that does not require interaction with a mouse or keyboard.

Further, it would be desirable for a user to have a device to remain engaged in the performance, or have their engagement experienced increased during use.

### SUMMARY OF THE INVENTION

The present disclosure is directed to an intuitive device, system, and method for controlling compensation and compensation-related parameters between two users. More specifically, in one aspect, the present disclosure describes an intuitive arrangement for a first user to engage an input device to control tipping for a second user.

In an aspect of the invention, the system disclosed herein allows a first user (e.g., customer) to tip or compensate a service provider (e.g., webcam performer, adult entertainer, etc.) by actively thrusting, stroking, or otherwise using a masturbation device. Movement or manipulation of the masturbation device will initiate, trigger, or otherwise cause a tip to be made to a service provider.

In an aspect of the invention, the input device used by the first user can be a sex toy, and more specifically can be a sex toy configured to detect movement or manipulation as the first user moves or otherwise uses the sex toy. Based on this movement or manipulation, an output signal or signals that are representative of the movement or manipulation are transmitted, such as by a processor or controller, to a server or network. Data related to the output signal is used to determine compensation (e.g., tipping) parameters, such as the amount of compensation, frequency of compensation, etc.

In an aspect of the invention, information regarding movement or manipulation parameters, such as the intensity, amount, or type of the user's movement or manipulation, i.e. frequency and amplitude of strokes performed by the user, is used to determine or otherwise calculate the compensation. For example, compensation may be increased or decreased if the frequency or intensity of the first user engaging the sex toy is increased or decreased.

In an aspect of the invention, manipulation of a user device or customer device is detected, and data associated with that manipulation is used to determine compensation.

In an aspect of the invention, a server or network for the system is configured to receive and transmit information regarding compensation and tips to one or more of the users. The second user, for example, can respond in real time to the first user's tipping activity to encourage further tipping. The second user may provide enhanced entertainment to the first user if the compensation or tips are increased. In this way, both parties remain engaged, even though they are remote.

In an aspect of the invention, the second user can also be provided with a sex toy which is controlled based on the amount of compensation or tipping from the first user. For example, as the first user engages a first sex toy, the compensation to the second user is increased, as well as the degree of actuation of the second user's sex toy. In other words, the first user's interaction with the first sex toy dictates both the compensation and stimulation provided to the second user.

In another aspect of the invention, a website or application (“app”) may be provided, allowing for setting parameters for the system. For example, and not by way of limitation, a website or application may allow a user to adjust or otherwise set tipping amounts, adjust or otherwise set tipping thresholds, adjust or otherwise set how tips are calculated, adjust or otherwise set payment options, or adjust or otherwise set device operation parameters.

Therefore, the present disclosure creates a more responsive interaction between two users.

Additional aspects of the invention are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates a first aspect of the present system.

FIG. 2 illustrates a schematic diagram of a system in which the arrangement of FIG. 1 is used.

FIG. 3 illustrates another schematic diagram of a system in which the arrangement of FIG. 1 is used.

FIG. 4 illustrates a flowchart illustrating one aspect of capturing data according to the system.

FIGS. 5A and 5B illustrate a flowchart of a method for a user to interact with the system.

FIG. 6 illustrates another embodiment of the system of FIG. 1 including an additional device.

FIG. 7 illustrates a system in which the arrangement of FIG. 6 is used.

FIG. 8 illustrates another system in which the arrangement of FIG. 6 is used.

FIGS. 9A and 9B illustrate a flowchart depicting one aspect in which the arrangement from FIGS. 6-8 is used.

FIG. 10 illustrates another embodiment of an input device used in the systems of FIGS. 1-9B.

FIG. 11 illustrates a flowchart disclosing a method according to one aspect of the invention.

FIG. 12 illustrates a flowchart disclosing a method according to one aspect of the invention.

FIG. 13 illustrates a flowchart disclosing a method according to one aspect of the invention.

FIG. 14 illustrates a flowchart disclosing a method according to one aspect of the invention.

### DETAILED DESCRIPTION

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced items unless specifically stated otherwise. This terminology includes the words above specifically mentioned, derivatives thereof, and words of similar import.

The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

In one aspect, the present disclosure generally discloses systems, methods, and arrangements in which tips or compensation are controlled by interaction with a sex toy or a wearable sensor.

In one aspect, the present disclosure includes systems, methods, and arrangements in which tips or compensation are controlled by interaction with a device. The interaction with the device can include any type of movement of the device, movement relative to the device that is detected by the device, or manipulation of the device. As used herein, the terms manipulation or movement can include at least one of: movement or manipulation of the device itself, movement or manipulation of at least one portion or element of the device, movement or manipulation of the device via interaction with a body part, movement relative to the device that is detectable by the device, movement or manipulation of a body part via the device, or any other type of use of the device. In one aspect, movement or manipulation of a body part via the device may include a stationary body part and a mobile device.

The terms movement, usage, engagement, and manipulation (including all variants of these terms) may be used interchangeably in some aspects described herein.

In one aspect, the movement or manipulation includes penetrative movement, thrusting movement, or stroking movement. In one aspect, movement or manipulation of at least one portion or element of the device could include a switch, slider, knob or other component attached or connected to the device. For example, a user could flip a switch, move a slider, or engage a knob in order to generate signals, which are then used to determine tips or compensation. In one aspect, movement or manipulation could include movement relative to the device that is detected or detectable by the device. For example, movement of a finger, hand, or male member relative to the device, even where the device itself may be stationary or may not be moved or moving, may be detectable by a device.

In one aspect, the device can include a computer mouse or other user interface or input device or screen that is associated with a computing device, such as a personal computer or smartphone. Movement or manipulation of the device in this aspect includes moving the computer mouse or clicking the computer mouse. For example, a user may move a computer mouse over a specific portion of an image or streaming video of a performer, or may move the mouse according to a predetermined pattern of movement which can be used to determine tipping or compensation parameters. In another aspect, a user may be required to click virtual images or elements produced on a computer monitor in order to determine tipping or compensation parameters.

In another aspect, the device can be a computing device such as a smartphone, tablet, or notebook with a touch-screen or movement sensor, and the associated movement or manipulation may include manually moving a finger along the screen of the device, pressing the screen of the device, or shaking or moving the device. In one aspect, using the device may include navigating or otherwise engaging software application (an “app”) on the device. The app may be configured to provide an interface in which usage of the app determines tipping or compensation parameters.

The embodiments disclosed herein provide a system in which manipulation of a device by a customer directly and instantly triggers compensation to a performer. This arrangement thereby encourages the customer to be an active participant in the system and during the performance by the performer. The system provides a fully interactive and dynamic arrangement in which the customer receives instant feedback, gratification, and satisfaction knowing that their movements directly trigger compensation to the performer, and the performer can instantly react to the compensation. The system provides a more engaged arrangement between the customer and the performer, which effectively encourages and drives tipping due to a continuous feedback loop provided between the customer and the performer. The aspects disclosed herein provide more interaction than a static arrangement in which compensation is manually set, and the parameters regarding that compensation may not be clear or transparent, or may not be triggered during a particular session between a customer and a performer. Instead, this system provides clear and instant feedback to both the customer and the performer regarding compensation being triggered directly based on manipulation of the device by the customer. While certain parameters regarding compensation may be set ahead of time and before a particular session, the compensation is provided on an ongoing basis during the session itself and is driven dynamically by the manipulation of the device by the customer.

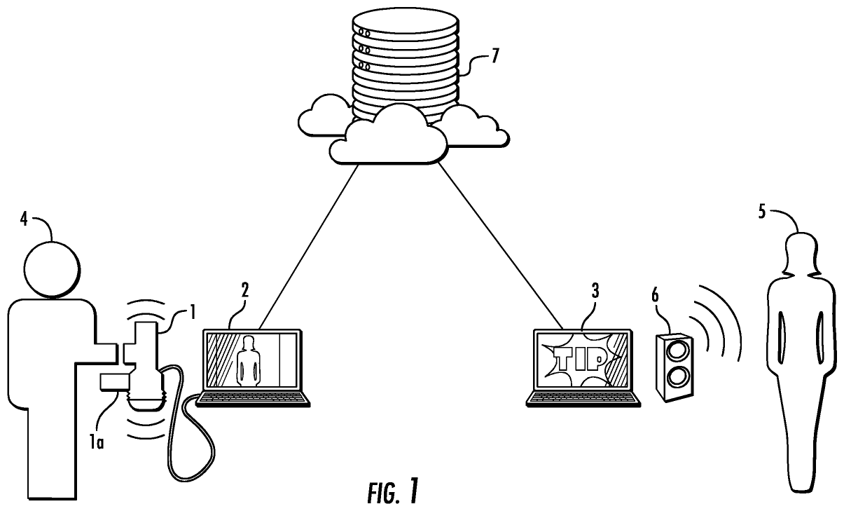

As shown in FIG. 1, an aspect of the system includes a sex toy 1 (which may also be referred to as an input device or a masturbatory aid). The sex toy 1 can be configured to be used or otherwise engaged by a male or a female. In one aspect, the sex toy 1 includes an outer housing and an inner sleeve defining an orifice configured to receive a male user's penis. The sex toy 1 can include an integral transmission unit configured to only send and/or receive data, or to send and/or receive signals such as electronic or other signals. In one aspect, the sex toy 1 can both send and receive data. The sex toy 1 can be a non-actuated or non-mechanized device. As used herein, the term non-actuated device or non-mechanized device refers to a device that lacks a motor or driving component to move internal component parts. In another embodiment, the sex toy 1 can include a motor that is driven based on the interaction with another user. For example, interactive sex toys are shown and described in U.S. Pat. No. 8,255,299, the entire contents of which is incorporated by reference herein.

As shown in FIG. 1, a first user 4 is illustrated engaging the sex toy 1. An electronic device 2 is also illustrated which is configured to display video. As an example, the electronic device 2 is configured to display video of a second user 5 that is in a remote location relative to the first user 4. The electronic device 2 may be, for example, a computer, laptop, tablet, smartphone or notebook.

The sex toy 1 preferably comprises one or more sensors for detecting movement or manipulation and configured to produce and send a signal in response to such detection. The sex toy 1 may further comprise one or more transmitters for sending a signal in response to movement or manipulation detected by the sensor. It is also appreciated that the sensor alone may be configured to transmit the signal or movement or manipulation data.

The second user 5 is also provided with an electronic device 3 that is configured to communicate with the electronic device 2 over a network via a server 7. As used herein, the term server may also refer to a network or cloud-based system in which data or information is stored and transmitted. For example, the sex toy 1, electronic device 2 and electronic device 3 may communicate over the internet, via wired or wireless communication.

As the first user 4 manually operates or engages the sex toy 1, at least one movement or manipulation signal is generated that is representative of or associated with the movement or manipulation of or engagement with the sex toy 1. For example, the signals may be representative of one or more movement or manipulation parameters, such as distance, degree, intensity, frequency, and direction of movement or manipulation of, or engagement between the first user 4 and the sex toy 1.

Signals from the sex toy 1 can be captured directly by the sex toy or via a sensor 1a, which is schematically illustrated in FIG. 1. The sensor 1a can be integrated within the sex toy 1 or can be separately provided and removably engaged with the sex toy 1. One of ordinary skill in the art would understand that the same sensor 1a illustrated in FIG. 1 can be implemented into the toys of any of the other toys or devices illustrated in the other Figures. As an example, a known FLESHLIGHT™ device could be equipped with a cap or band comprising a sensor for use with the present system.

The sensor 1a can include any one or more of the following types of sensors: pressure sensors, piezoelectric sensors, break beam or optical sensors, accelerometers, gyroscopes, ultrasonic sensors, proximity sensors, and/or infrared sensors.

The sensor 1a may include electronics configured to send or otherwise transmit a signal associated with movement or manipulation of, or engagement with the sex toy 1. A separate transmitter may also be provided, such as a wireless transmitter configured to send, for example, a Bluetooth, WiFi, or other wireless signal.

The sensor 1a can be provided on a band or other attachment component that is capable of attaching to a variety of different types of sex toys or attaching directly to a user's body. For example, U.S. Pat. Nos. 7,762,945 and 10,143,618, the entire contents of each of which is incorporated by reference as if fully set forth herein, show bands that can be worn by a user or placed around a device, and include sensors for transmitting signals while using, for example, sex toys. U.S. Pat. No. 6,793,619, which is also incorporated by reference as if fully set forth herein, describes a system for giving a user tactile feedback, and a system for providing an interactive display and manipulation of images.

The sensor 1a can have a wired or wireless connection (e.g., Bluetooth, WiFi, etc.) to the electronic device 2 or other processer or computing device capable of receiving signals from the sensor.

A communication channel is established between the sex toy 1 and the electronic device 2 in order to provide data and information regarding the first user's interaction with the sex toy 1. This channel can be provided in either a wired or wireless configuration. The electronic device 2 communicates information regarding the first user's interaction with the sex toy 1 to the server 7.

The server 7 is preferably configured to receive and transmit data and signals between and among the sex toy 1, and the electronic devices 2, 3. The server 7 is also configured to process financial transactions between the two users 4, 5. Specifically, the server 7 is configured to transfer money from the first user 4 to the second user 5 in the form of tips, in one aspect. Compensation from the first user 4 to the second user 5 can be provided in a variety of forms, such as credits, currency, tokens, and other forms of payment.

Upon receipt of a tip or compensation, the electronic device 3 can be configured to provide a notification to the second user 5. In an aspect of the invention, a sound can be played by an audible emitting device or speaker 6 upon receipt of the tip. That sound can be, for example and not by way of limitation, a bell, a cash register chime, or a series of musical notes.

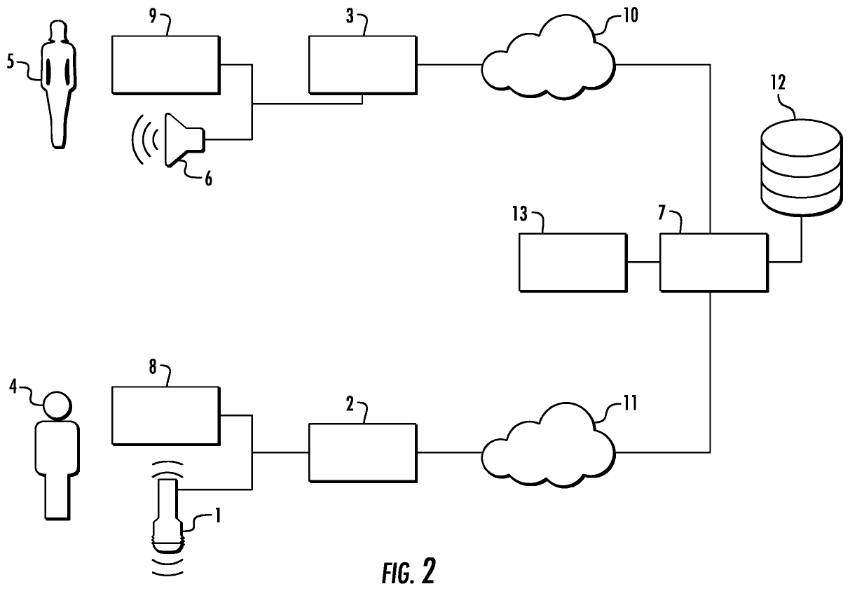

As shown in FIG. 2, the first user 4 may access the system via a website or computer program such as an “app” (application). The website or app comprises software or a computer program or code configured to provide for the processes of the invention.

An interface, such as a web or app interface 8, on the electronic device 2 is provided for accessing the website or app. The web or app interface 8 is configured to provide communication via accessing an internet connection 11, and the server 7 is accessed via the internet connection 11. A remote memory or storage unit 12 is provided in connection with the server 7. Additionally, a user interface 13 for the system is also stored on the server 7. The interface 13 can include a webpage, internet-based application, smartphone app, or other type of interface. The storage unit 12 can store information regarding users' demographic information, profiles, payment information and history, registration information, as well as any other credentials or information regarding users. The interface 13 can include a chat or “instant message” module that allows the users 4, 5 to communicate with each other, specifically via video chat.

The second user 5 accesses the system in a similar configuration as the first user 4. The second user 5 accesses the system via a web or app interface 9 on the electronic device 3, which also has an internet connection 10. FIG. 2 also illustrates an audio device or speaker 6.

During use, the first user 4 moves or otherwise engages the sex toy 1, and signals are generated that are representative of the user's movement, manipulation, or engagement with the sex toy 1. The signals are associated with movement or manipulation of or engagement with the sex toy 1. The signals may further be associated with, proportional to, or relative to the manner in which the first user 4 is using the sex toy 1. The signals generated due to the first user 4 using the sex toy 1 can be generated directly by the sex toy 1 or by the sensor 1a (as shown in FIG. 1). A microprocessor comprising a sensor, and which may also include a transmitter, may be integrally formed as part of the body or casing of the sex toy 1. Other configurations for capturing data regarding use of the sex toy 1 can also be used.

Data regarding the movement, manipulation or engagement of the sex toy 1 in connection with the first user 4 is captured or otherwise detected by the sensor 1a and a representative signal is sent via the transmitter 1b to the server 7 via the internet connection 11. Based on this data, the server 7 then sends a corresponding signal to the second user 5. In one aspect, the server 7 is configured to essentially translate or convert the data regarding the first user's engagement with the sex toy 1 into information that is used to set a compensation parameter in connection with a payment made to the second user 5.

The server 7 can access software stored in the storage unit 12 to update the interface 13 to provide information or an indication regarding the first user 4 and their engagement with the sex toy 1, as well as compensation to the second user 5. The speaker 6 can be triggered by the system to provide audible indications (such as cash register noises or coins clinking with each other) that compensation is being provided to the second user 5.

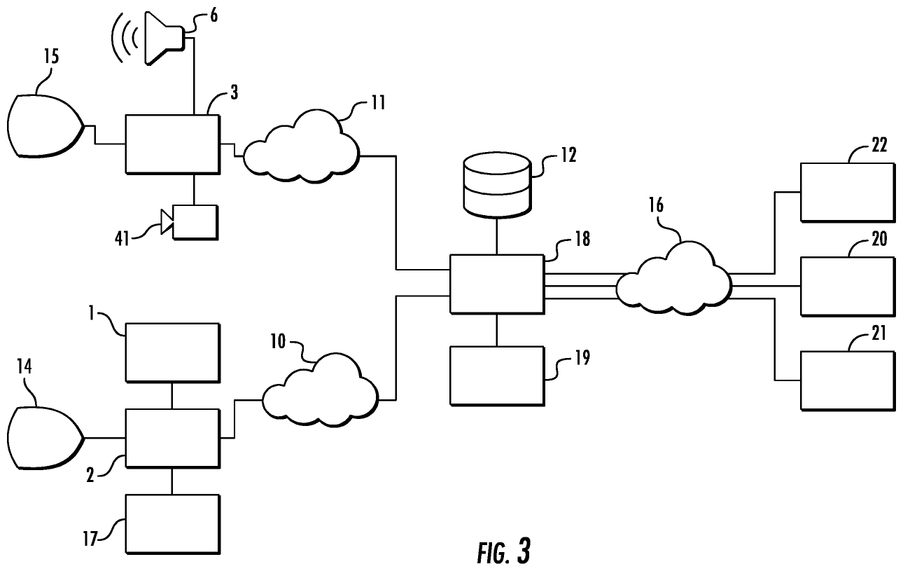

FIG. 3 illustrates another system in which a sex toy 1 can be used by a first user to control the payment of compensation to the second user. In FIG. 3, the first user's electronic device 2 receives data generated by the toy 1 (or an associated sensor), and the electronic device 2 is configured to run software or a program 17 which is configured to receive data related to physical input with or movement or manipulation of the toy 1 and convert this data to compensation information. Information from the software 17 is sent to the server 18, which is configured to then send compensation and notifications related to the information from the first user and software 17 to the second user via the electronic device 3.

On the first user's end, a display 14 is provided that displays images recorded from the second user's end via camera 41. The display 14 can show live streaming images of the second user. Likewise, the second user has a display 15 that can also display images of the first user, and/or information regarding compensation from the first user. A camera can also be provided for the first user, via a web camera, smartphone camera or other camera device.

Internet connections 10, 11 can provide the data channel for sending information and data between the two users through the system. One of ordinary skill in the art would understand that other types of connections and configurations can be provided.

On a back end or remote end of the system, the server 18 is connected to a database 12, a software server 19, internet connection 16, and financial components (e.g., bank module 22, merchant account module 20, and payout vendor module 21). One of ordinary skill in the art would understand that the payment configuration and settings can vary.

The database 12 can store information regarding users' profiles, financial information, passwords, history, etc. The server 18 is configured to process financial transactions between the users and the bank module 22, the merchant account module 20, and the payout vendor module 21. The system operator can be configured to divert a portion of each tip or compensation amount to the bank module 22, which is owned and controlled by the system operator, while the remainder of the tip or compensation goes to the second user (e.g., webcam performer) via the merchant account module 20.

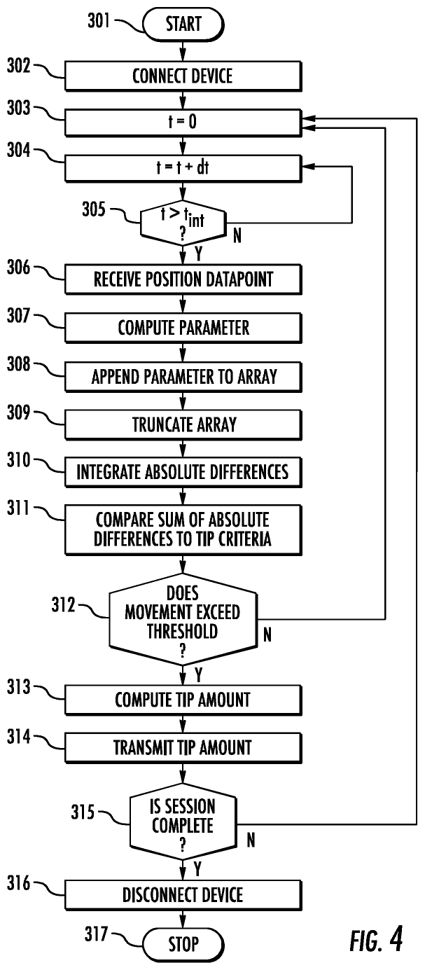

The system includes a process for determining various compensation parameters. FIG. 4 illustrates a flowchart showing an example of the operation of the system such as via a software module 17 comprising software configured to execute the process. The software module 17, among other functions, converts data related to the first user's movement or manipulation of or engagement with the toy 1 into data that is associated with, proportional to, and/or representative of compensation or tips to be paid to the second user.

The process commences at step 301, and then moves onto step 302 which includes connecting the toy 1 for data communication, i.e. via an internet connection or other data channel. In order to synchronize the information, the system sets a time variable (t) to zero at step 303. As the process is carried out, incremental factors dt are added to the time variable (t) at step 304. Step 305 includes a comparison of whether the time variable (t) exceeds time interval t(int). If so, then the software component accesses a data point indicating a physical state of the toy 1. If time variable (t) does not exceed time interval t(int), then the software component returns to step 304 to incrementally increase time variable (t). Once position data point has been acquired at step 306, then the system computes specific parameter related to a physical state of the toy at step 307.

At step 308, the system appends a parameter to an array which is used to store a range of sequential data points for computation of fluctuation which is related to intensity of use of the toy 1.

In step 309, the system discards the oldest data point in the array and the system computes the sum of the absolute differences between subsequent data points in step 310. Step 311 includes a comparison to a predetermined criterion, and step 312 includes a check of whether the movement or manipulation of the toy 1 exceeds a threshold movement. These steps are provided to ensure that minimal movement or manipulation, or incidental movement or manipulation of the toy 1 does not trigger the compensation threshold. These steps also allow for calibration and setting regarding the requisite degree of movement or manipulation of the toy 1 to trigger tipping. These values can be set by individual users or administrators of the system.

If the sum of the absolute differences exceeds the predetermined criterion or threshold, then the system proceeds to compute a tip amount based on the value of the sum of the absolute differences at step 313. If the sum of the absolute differences does not exceed the arbitrary criterion, then the system returns to step 303 to collect more data. Data related to tip amount is transmitted to the server 18 in step 314. Step 315 includes a periodic query regarding whether the session is complete. If not, then the steps are repeated. If so, then the process proceeds to step 316 which includes disconnecting the toy 1 and terminating the session at step 317. By having an iterative process, to check for movement or manipulation of the toy 1, the system ensures that inadvertent tipping does not occur.

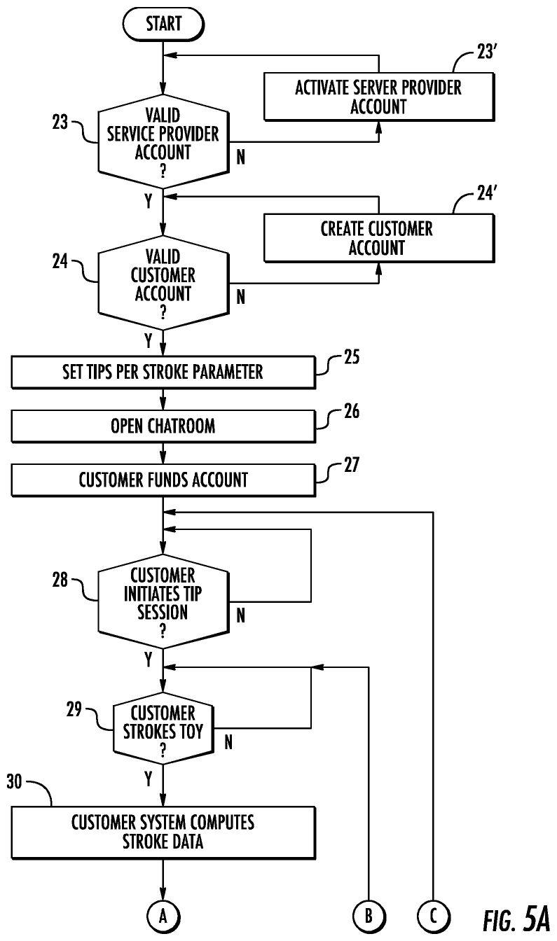

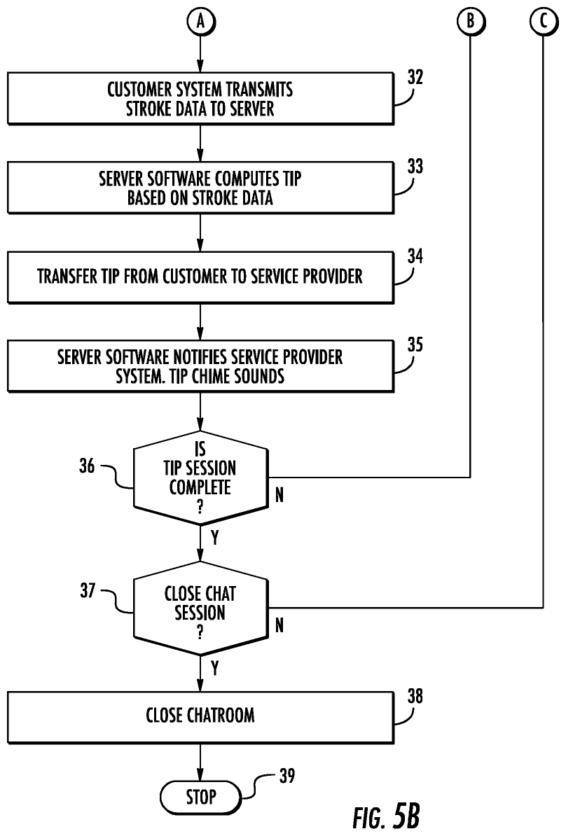

FIGS. 5A and 5B illustrate a flow chart of the method of the present invention. As shown in FIGS. 5A and 5B, the process begins at the start step. Step 23 then includes determining if there is a valid service provider account.

If the service provider account does not exist or is not valid, then the system is configured to create or activate a service provider account at step 23′. If the service provider account is valid, then the system determines if is a customer account is valid at step 24. If the customer account is not valid, then the system creates a customer account at step 24′. Steps 23, 24, 23′, and 24′ essentially ensure that the first user (e.g., customer) and the second user (e.g., the entertainer or performer) have valid accounts.

Step 25 allows users to set tips or compensation based on calculated movement or manipulation data, such as by way of example the number of strokes, detected by the sensor of the sex toy 1. For example, a tip may be provided every n times that the sex toy is moved in a single back-and-forth or up-and-down stroke, where n is a user-selected number of strokes. For example, in one aspect, a stroke is equal to anywhere from $0.01 to $1,00. One skilled in the art would understand that the exact compensation per stroke will vary depending on multiple factors.

Step 26 includes opening a communication channel, such as a chat room or webcam display, which can include a live video connection or transmission. Users can fund an account stored on the system at step 27, such as via a credit card, PayPal®, Venmo®, etc. These funds are then ultimately transferred to the second user as compensation or tipping based on how the first user engages the toy. Step 28 includes initiating a tipping session. The system then waits for the customer to stroke the device or sex toy in step 29.

Step 30 includes the user moving or otherwise engaging the sex toy 1 to generate a signal comprising or associated with movement or manipulation data. As explained with respect to FIG. 4, the system may be set such that movement or manipulation of the toy must preferably exceed a predetermined threshold to trigger compensation or the computation of compensation via the system. The system may compute strokes (movement or manipulation) related data in step 30 and computes tip data based on the stroke (movement or manipulation) data in step 32.

Steps 32 and 33 include transmitting the movement or manipulation data to a server and then computing the compensation or tips based on the movement or manipulation data. Step 34 includes transferring the funds from a customer's account to the service provider's (e.g., webcam model's or webcam website operator's) account. At step 35, the system notifies the service provider that compensation has been provided or a tip has been awarded via a notification, such as a chime.

Step 36 checks whether the session is complete. If not, then the steps in FIGS. 5A and 5B are carried out again. If so, then the chat session is closed at steps 37 and 38. Finally, step 39 includes stopping the process initiated at step 22.

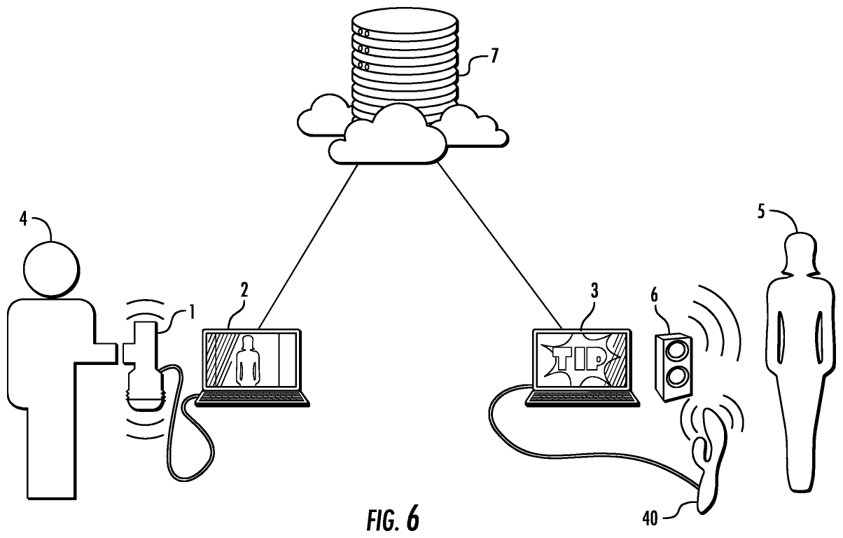

FIG. 6 illustrates another embodiment of the system in which an additional toy is provided for the second user 5. As shown in FIG. 6, the first user 4 is manipulating a sex toy 1, and signals, information, and data regarding the manipulation of the sex toy 1 is communicated to the remote server 7. The embodiment of FIG. 6 differs from FIG. 1 in at least one aspect regarding the second user 5. As shown in FIG. 6, a secondary sex toy 40 is provided for the second user 5. The sex toy 40 can be an actuated or mechanized sex toy. In other words, the sex toy 40 can include a motor or other driving mechanism configured to provide an output force or provide movement to the sex toy 40.

In one aspect, the sex toy 40 is driven based on the compensation or tips from the server 7. Signals from the first sex toy 1, such as intensity, frequency, and direction of movement or manipulation by the first user 4 is used to drive the sex toy 40 in a corresponding and proportional manner. The amount of tip or compensation can also be used to provide a greater impulse or driving instructions to the second toy 40, therefore providing greater sensation to the second user 5.

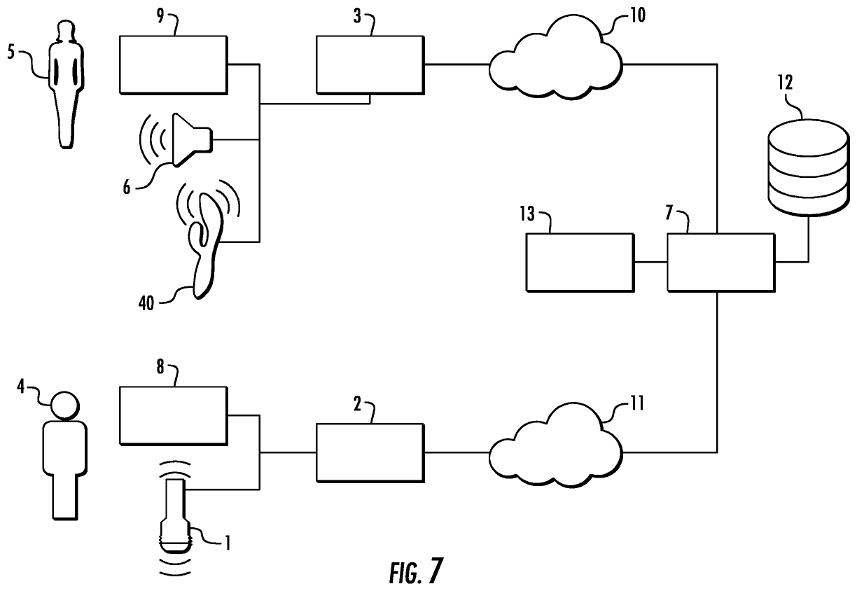

FIG. 7 illustrates the arrangement shown in FIG. 6 in greater detail. FIG. 7 illustrates similar components as FIG. 2, and these components operate in a similar manner as described with respect to FIG. 2 unless explicitly described in more detail herein. As shown in FIG. 7, the first toy 1 (e.g., a non-actuated device) receives physical impulses from the first user 4 to create a signal. This signal is then sent through the internet to the server 7, and ultimately used by the system to generate two types of data: (i) compensation or tip data, and (ii) physical output signals for actuated toy 40. Any aspect of either of these types of data can be proportional or related to the first user's engagement with the sex toy 1. For example, the intensity of the first user's engagement with the sex toy 1 can result in a greater physical output to the sex toy 40 as well as more compensation. Likewise, the frequency and duration can also be detected by the first toy 1 to similarly drive the frequency and duration of the output to the sex toy 40.

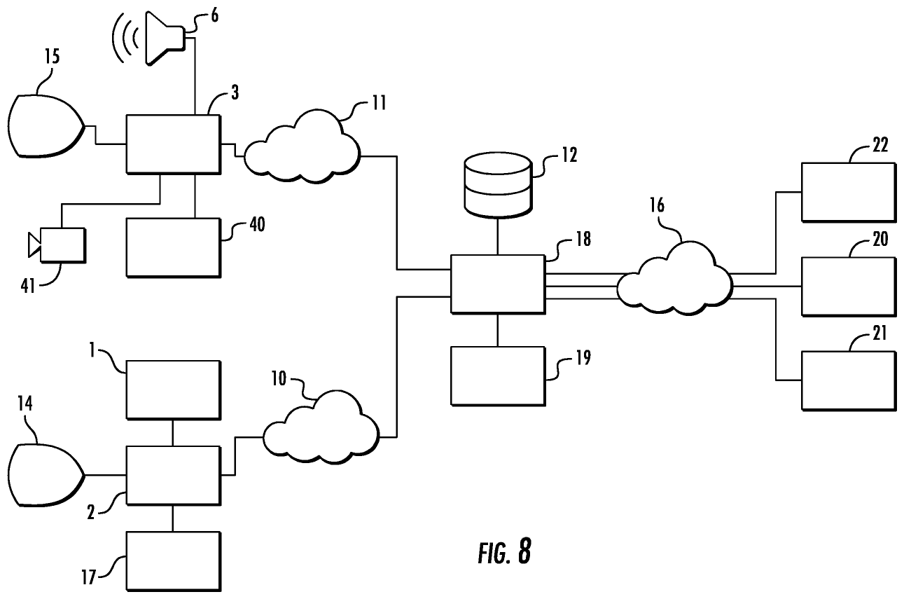

FIG. 8 is analogous to FIG. 3, with a modification to illustrate the actuated toy 40. All other aspects and components shown in FIG. 8 operate in a similar manner as disclosed with respect to FIG. 3.

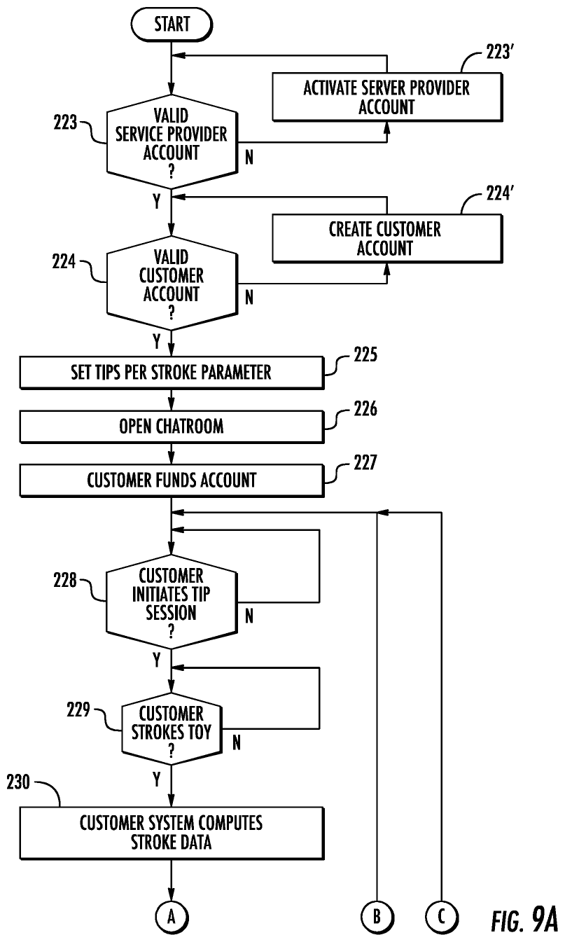

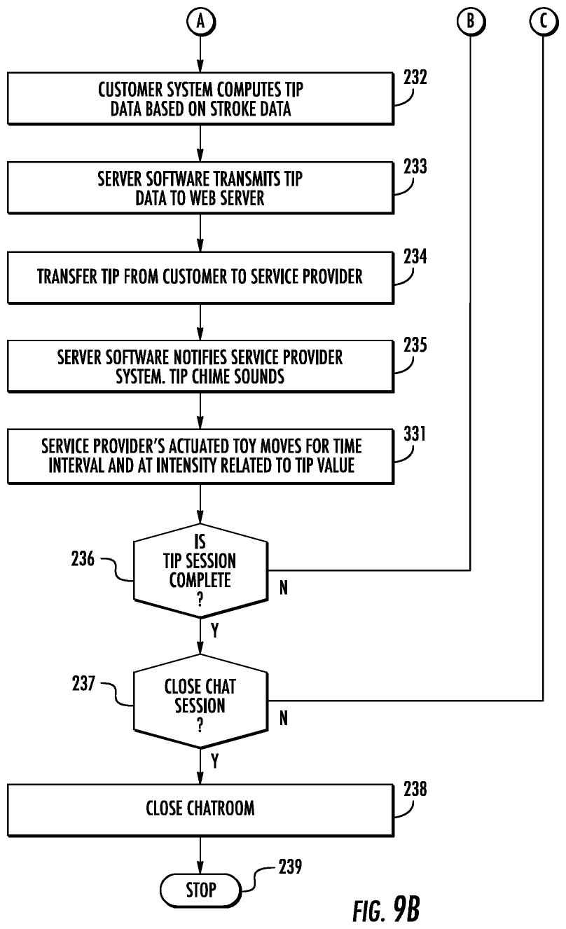

FIGS. 9A and 9B illustrate a flowchart of the present system that is similar to the flowchart illustrated in FIGS. 5A and 5B. Similar steps are indicated with a reference numeral 2 ##, where the “##” correspond to the same numbers as shown and described in FIGS. 5A and 5B, and are not described in more detail herein but operate in the same manner.

FIG. 9B illustrates step 331, in which the system provides movement or manipulation data and signals to drive the service provider's actuated toy, e.g., toy 40 from FIGS. 6-8. The duration, intensity, and frequency of movement or manipulation of the toy 40 may be related to the compensation. Similarly, the duration, intensity, and frequency of movement or manipulation of the toy 40 may be proportional to the duration, intensity, and frequency of movement of the toy 1. For example, faster or more intense movement or manipulation of the toy may result in greater or more frequent tipping.

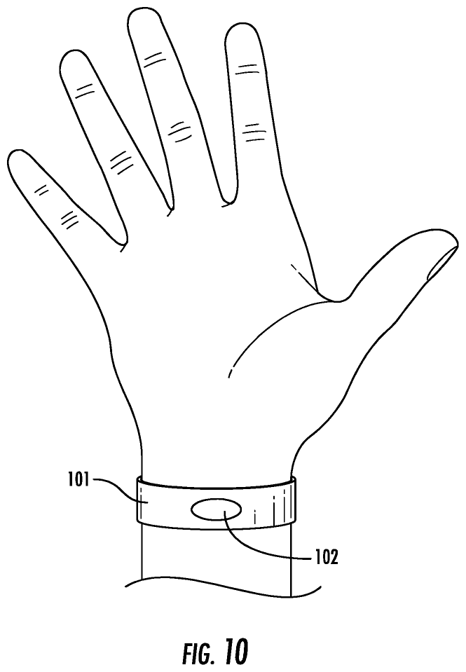

In another embodiment shown in FIG. 10, a wristband 101 with a sensor 102 is provided. The wristband 101 is configured to be worn by first user as the first user moves their hand during masturbation. The wristband 101 can be formed by an elastic material or a non-elastic material with a fastener.

The sensor 102 in the wristband 101 is configured to measure and transmit data related to the speed and degree of the user's masturbation to a connected processor, and that data is subsequently used to compute and transmit data related to the tip to be sent the service provider. All other aspects of the system are identical to those described with respect to FIGS. 1-9B, except that the wristband 101 is used instead of a sex toy 1. The wristband 101 can be integrated within any one or more of the embodiments disclosed in FIGS. 1-9B.

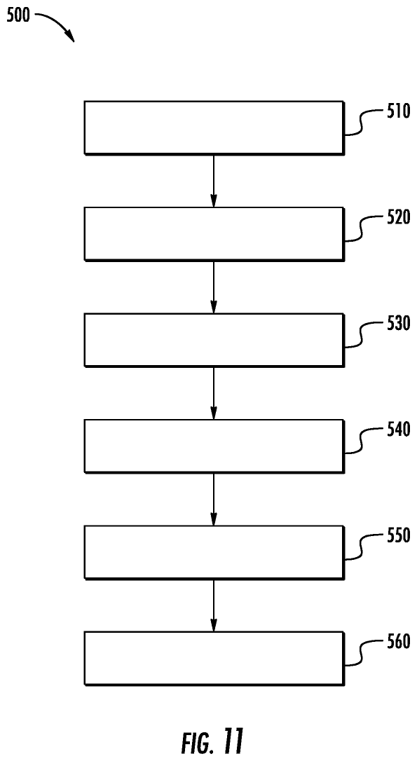

Another aspect of the system 500 is provided as FIG. 11. As shown, at step 510, a customer accesses a website or application and sets one or more tipping parameters, such as: amount of tip per detected movement or manipulation signal; amount or type of movement or manipulation needed to generate a tip; number or timing of strokes needed to generate a movement or manipulation signal; and/or funds to draw tips from.

At step 520, the customer may register the sex toy with the system, such as by connecting the sex toy wirelessly to be recognized by the system, and creating a customer account on the server including, for example, a user name and password. The customer may open an account and connect a form of payment to the user account, such as a credit card, PayPal account, or Venmo account.

At step 530, a user may access a website or application to provide for communication with a performer over a network. For example, a user may access a webcam site and select a performer. Generally, the performer has a video camera (which may be on a computer or smartphone), for sharing a video feed with the customer, who can view the webcam performer through a display on a webpage or through an application.

At step 540, the customer moves the sex toy. This generates a signal associated with movement or manipulation data. The signal is proportional to the movement or manipulation data, in one aspect.

At step 550, the server receives the signal. The server accesses the customer account information and any tipping parameters set by the customer.

At step 560, the server provides payment in the form of tips as calculated according to the tipping parameters and as associated with the signal and/or movement or manipulation data. These tips may be sent to an account associated with the performer.

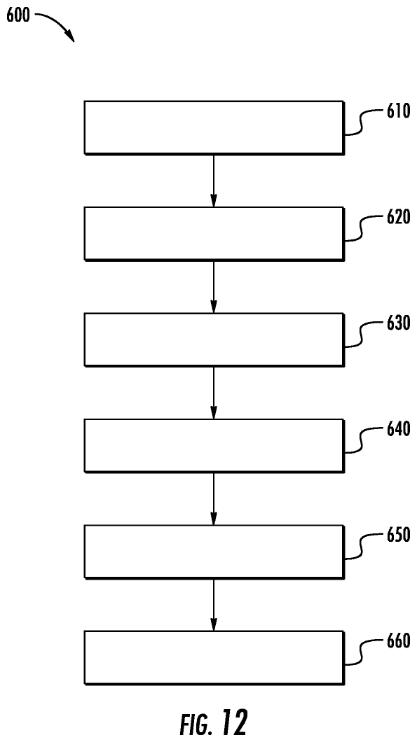

Another aspect of a configuration or method 600 is disclosed in FIG. 12. As shown in FIG. 12, a method of providing for compensation in an interactive system is illustrated. The method includes connecting a customer device and a performer device via a network at step 610. The devices can include sexual toys, in one aspect. The method then includes displaying a video feed of the performer to the customer at step 620. The video feed can be displayed via personal computers or smartphones, in one aspect. Next, the method includes transmitting a signal from the customer device comprising movement or manipulation data in response to movement or manipulation of the customer device at step 630. The movement or manipulation data can essentially reflect the degree, intensity, frequency, and/or duration of movement or manipulation of the customer device, in one aspect. Step 640 includes determining compensation parameters associated with the customer device. Step 650 includes providing compensation based on the compensation parameters to a performer account. Step 660 then ends or terminates the session after a termination event.

In one aspect, compensation to the performer only begins after an initial predetermined amount of manipulation of the customer device occurs. In other words, there must be a threshold amount of usage of the customer device in order to begin paying the performer. In one aspect, this threshold amount of usage or initial predetermined amount of manipulation can be based on the frequency of movement or manipulation of the device, the amount of displacement of the device, or some other measurable usage or manipulation of the device that indicates that the user is sufficiently engaging the device. In one aspect, this configuration avoids situations in which inadvertent or random movement or manipulation of the device could trigger accidental compensation to the performer.

Once the user is sufficiently manipulating the device and the initial predetermined amount of manipulation occurs, compensation can continue at a predetermined interval until a termination event. In one aspect, the predetermined interval may be set to trigger compensation, such as one dollar, for every minute. Compensation parameters and intervals can be selected by the performer. In one aspect, these intervals and parameters cannot be changed once a session begins. One skilled in the art would understand that these parameters could vary.

In one aspect, the termination event can include the customer stopping manipulation of the customer device for a predetermined period, the video feed of the performer being terminated, or another event. Compensation will discontinue in the event that the customer has stopped using the device for the predetermined period. In one aspect, the predetermined period can be set to ten seconds, and more preferably can be set to seven seconds. One skilled in the art would understand that these parameters could vary. The video feed of the performer can be terminated either by the customer, the performer, or a third party hosting the video feed, all of which will stop compensation being paid from the customer to the performer.

Another aspect of a method is disclosed in FIG. 13. As shown in FIG. 13, the method 700 includes providing compensation in an interactive system. The method includes providing a customer device comprising a sensor at step 710. The sensor is configured to detect movement or manipulation and send a signal comprising movement or manipulation data, in one aspect. The sensor can include any type of sensor, such as pressure sensors, piezoelectric sensors, break beam or optical sensors, accelerometers, gyroscopes, ultrasonic sensors, proximity sensors, and/or infrared sensors. The signal can include multiple parameters regarding the movement or manipulation, such as intensity, frequency, duration, fluctuations, etc. Step 720 includes transmitting the signal via a network to a server. The method includes determining compensation for payment to a performer based on the signal at step 730. Next, step 740 includes providing compensation to a performer based on the determination. In one aspect, the compensation is directly related to at least one aspect of the movement or manipulation data.

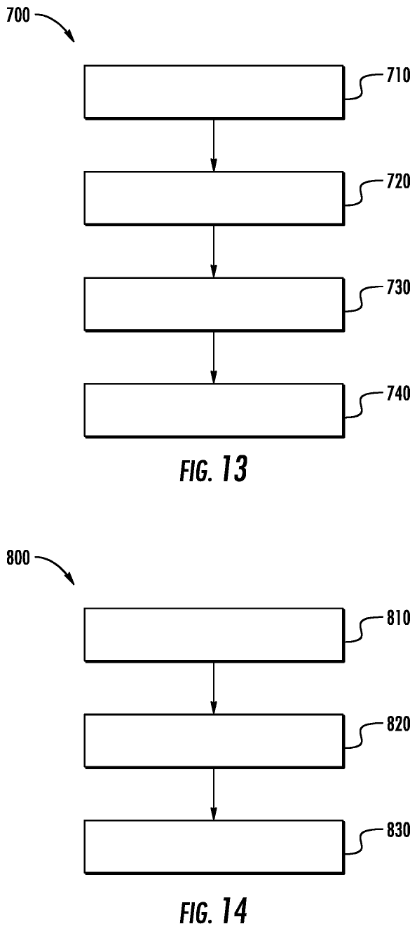

FIG. 14 illustrates another method 800 for providing for compensation in an interactive system. The method 800 includes determining movement or manipulation data based on movement or manipulation of a device comprising a sensor associated with a first user at step 810. This step can include a first user, such as a customer, manually manipulating the device such that the sensor detects movement or manipulation data. Step 820 includes sending the movement or manipulation data to a server. In one aspect, the server is remote from the first user. Next, step 830 includes determining compensation to be paid to a second user based on the movement or manipulation data. In one aspect, this step includes providing compensation that is proportional to the movement or manipulation data.

One skilled in the art would understand that any one or more of the steps disclosed in the flowcharts or methods of FIGS. 4, 5A, 5B, 9A, 9B, and 11-14 can be omitted or included in any of the other methods. For example, steps from FIGS. 4, 5A, 5B, 9A, and 9B can be adapted to be included with any one or more of the method steps of FIGS. 11-14, and vice versa.

Having thus described the present embodiments in detail, it is to be appreciated and will be apparent to those skilled in the art that many physical changes, only a few of which are exemplified in the detailed description of the embodiments, could be made without altering the inventive concepts and principles embodied therein.

A system and method are disclosed herein that allows a customer to engage a service provider in a chatroom, and the customer can provide tips to the service provider simply by engagement with a sex toy. The system is configured to detect the movement or manipulation of the sex toy by the customer such that tips sent to the service provider are proportional to the customer's engagement with the sex toy. This is achieved without any use of manual input devices or interfaces, such as a keyboard or computer mouse. In other words, the input device or sex toy being used by the first user lacks any buttons or other keys which would need to be engaged to dictate how much is tipped to the second user.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

What is claimed is:

1. A method of providing for compensation in an interactive system, the method comprising:
connecting a customer device and a performer device via a network;
displaying a video feed of a performer to a customer;
transmitting a signal from the customer device, the signal comprising data in response to manipulation of the customer device;
determining compensation parameters associated with the customer device; and,
providing compensation based on the compensation parameters to a performer account.

2. The method according to claim 1, wherein the customer device includes a sensor is configured to detect thrusting movement, stroking movement, or penetrative movement.

3. The method according to claim 1, wherein the compensation is proportional to manipulation intensity or manipulation frequency of the customer device.

4. The method according to claim 1, wherein the interactive system provides a communication channel between the customer and the performer.

5. The method according to claim 4, wherein the communication channel is configured to provide live streaming video of the performer.

6. The method according to claim 1, wherein the performer device is a mechanized sex toy and the customer device is a non-mechanized sex toy.

7. The method according to claim 1, wherein the manipulation includes at least one of: movement of an entirety of the customer device, movement of at least one portion of the customer device, or movement of the customer relative to the customer device.

8. The method according to claim 1, wherein the compensation begins after an initial predetermined amount of manipulation of the customer device occurs, and
the compensation continues at a predetermined interval until at least one of: the customer stops manipulating the customer device for a predetermined period, or the video feed of the performer is terminated.

9. A method of providing compensation in an interactive system, the method comprising:
providing a customer device comprising a sensor, the sensor configured to detect manipulation of the customer device, and send a signal comprising data associated with the manipulation;
transmitting the signal via a network to a server;
determining compensation for payment to a performer based on the signal; and,
providing compensation to a performer based on the determination.

10. The method according to claim 9, wherein the sensor is removable from the customer device, and the sensor is configured to be attached to differently sized and shaped devices.

11. The method according to claim 9, wherein the compensation is proportional to manipulation intensity or manipulation frequency of the customer device.

12. The method according to claim 9, wherein a performer device is configured to be engaged by the performer, wherein the performer device includes a motor that is configured to be driven based on the compensation provided to the performer.

13. The method according to claim 12, wherein at least one of: (i) an intensity of movement, (ii) a duration of movement, or (iii) a frequency of movement provided by a motor of the performer device is proportional to an amount or frequency of the compensation.

14. A method of providing compensation in an interactive system, the method comprising:
determining data based on manipulation of a device comprising a sensor associated with a first user;
sending the data to a server; and
determining compensation to be paid to a second user based on the data.

15. The method according to claim 14, wherein the sensor is configured to detect thrusting movement, stroking movement, or penetrative movement.

16. The method according to claim 14, wherein the compensation is proportional to manipulation intensity or manipulation frequency of the device.

17. The method according to claim 14, wherein the sensor is removable from the device, and the sensor is configured to be attached to differently sized and shaped devices.

18. The method according to claim 14, wherein the interactive system provides a communication channel between the first user and the second user.

19. An interactive system comprising:
a first device comprising a sensor, the first device configured to be engaged by a first user, to detect manipulation data via the sensor, and to transmit a signal in response to detecting the manipulation data; and
a server configured to receive the manipulation data transmitted by the first device;
wherein manipulation of the first device triggers compensation to a second user.

20. The system according to claim 19, wherein the compensation is provided in the form of at least one of currency, tokens, or credits.

21. The system according to claim 19, wherein the sensor is configured to detect thrusting, penetrative, or stroking movement.

22. The system according to claim 19, wherein the first user is a customer and the second user is a performer.

23. The system according to claim 19, wherein the compensation is proportional to manipulation intensity or manipulation frequency of the first device.

24. The system according to claim 19, wherein the sensor is removable from the first device, and the sensor is configured to be attached to differently sized and shaped devices.

25. The system according to claim 19, wherein the interactive system provides a communication channel between the first user and the second user.

26. The system according to claim 19, further comprising a second device configured to be engaged by the second user, wherein the second device includes a motor that is configured to move based on the compensation provided to the second user.

27. The system according to claim 26, wherein at least one of: (i) an intensity of movement, (ii) a duration of movement, or (iii) a frequency of movement provided by the motor of the second device is proportional to an amount or frequency of the compensation.

28. The system according to claim 26, wherein the second device is a mechanized sex toy and the first device is a non-mechanized sex toy.

29. The system according to claim 19, further comprising a web interface configured to be accessed by the first user and the second user, and the server provides a connection to the web interface, wherein the web interface provides a communication channel between the first user and the second user.

30. The system according to claim 29, wherein the communication channel is configured to provide live streaming video of the second user.

31. The system according to claim 19, further comprising an audible emitting device configured to play a sound when compensation is provided to the second user.

32. The system according to claim 19, wherein the first device lacks any buttons or keys.

33. An input device comprising:
an attachment element configured to attach to a first user's body; and
a sensor configured to detect movement of the first user's body and generate a corresponding signal based on the movement,
wherein the signal is transmitted to a server which provides compensation to a second user based on the signal.

34. The input device according to claim 33, wherein the compensation to the second user is proportional to an intensity of movement detected by the sensor.

35. The input device according to claim 33, wherein the signal transmitted to the server is also used to provide input driving signals to a secondary device used by the second user.

36. An interactive system for providing compensation from a first user to a second user, the system comprising:
a first sex toy configured to be engaged by the first user, the first sex toy being configured to send signals related to the first user's manipulation associated with the first sex toy; and
a second sex toy that is configured to be engaged by the second user,
wherein both: (i) actuation of the second sex toy, and (ii) an amount of compensation to the second user are based on the signals from the first sex toy.

37. The system according to claim 35, wherein the signals from the first sex toy are provided entirely based on motion, manipulation, or engagement of the first user relative to the first sex toy.

38. The system according to claim 36, wherein the first sex toy is non-actuated and the second sex toy is actuated.
